(19) United States
(12) Patent Application Publication
(10) Pub. No.: US 2017/0210497 A1
(43) Pub. Date: Jul. 27, 2017

(54) MACHINE FOR PACKAGING PRODUCTS WITH STRETCH FILM

(71) Applicant: GRUPPO FABBRI VIGNOLA S.p.A., Vignola (IT)

(72) Inventors: Stefano Ravazzini, Castellarano, Province of Reggio Emila (IT); Andrea Schiavina, Correggio, Province of Reggio Emila (IT)

(21) Appl. No.: 15/327,908

(22) PCT Filed: Jul. 15, 2015
(86) PCT No.: PCT/EP2015/066146

§ 371 Date: Jan. 20, 2017

(30) Foreign Application Priority Data
Jul. 23, 2014 (IT) BO2014A000418

(51) Int. Cl. B65B 11/00; B65B 51/18; B65B 35/10; B65B 59/04; B65C 1/02; B65B 11/48; B65B 57/00

(52) U.S. Cl. CPC B65B 11/004; B65B 11/48; B65B 51/18; B65B 57/005; B65B 59/04; B65C 1/02; B65B 35/10

(57) ABSTRACT

Machine for packaging products with stretch film the flaps of which are stretched, folded and mutually superimposed on the bottom of the product usually arranged in a tray, comprising a final station with a motorized heat-sealing conveyor to mutually secure said flaps with a heat-sealing operation, characterised in that this final heat-sealing station is provided with an upper protective chamber for the operator, and which limits the loss into the work environment of heat produced by said heat-sealing conveyor, now incorporated in this protective chamber, which has a shape and size such as to allow the packaged products to be conveyed therethrough without interference, this protective chamber being provided with an inlet opening usually communicating with the casing of the packaging machine and being provided with an outlet opening for conveying the packaged products, wherein at least this last outlet opening is closed by a swinging barrier that prevents loss of heat towards the outside and that is arranged to swing and open only in the direction of normal flow of the packaged products and due to the thrust of these latter, but which cannot swing in the opposite direction, to act also as safety barrier, said protective chamber being provided on at least one of the walls not involved by said swinging barriers and in view, with at least one window closed by at least one door preferably made of transparent material, which in the open position allows the operator to rapidly remove the packaged product optionally stationary on the heat-sealing conveyor, there being provided safety means to automatically shut down at least the power supply to this heat-sealing conveyor when said door is opened.

### CROSS-REFERENCE TO RELATED APPLICATIONS

The present application claims priority to PCT International Application No. PCT/EP2015/066146 filed on Jul. 15, 2015, which application claims priority to Italian Patent Application No. BO2014A000418 filed Jul. 23, 2014, the entirety of the disclosures of which are expressly incorporated herein by reference.

### STATEMENT RE: FEDERALLY SPONSORED RESEARCH/DEVELOPMENT

Not Applicable.

### BACKGROUND

The invention relates to machines for packaging products with stretch film, belonging to IPC class B65B11/54, adapted to produce packages as shown in FIG. 1 of the accompanying drawings, composed of a sheet of stretch film S, usually horizontal, which is stretched and taken to intimately wrap, with a vertical relative movement, a product V1 usually arranged in a tray or other container, under which there are then folded in an orderly manner, as indicated by the arrows Z of FIG. 1, the lateral flaps L1, L2, followed by the back flap L3 and finally the front flap L4 of the sheet of film S, while the packaged product V2 leaves the packaging station with a movement in the direction indicated by the arrow F1 of FIG. 2, which shows a perspective view of the same package, formed and overturned. Before leaving the machine, the packaged product V2 is conveyed resting with its lower flaps L1-L4 superimposed on a heated conveyor which provides for the mutual heat sealing of the same flaps and provides for blocking the package to prevent it from being accidentally separating or even opening.

### BRIEF SUMMARY

The invention intends to provide machines for producing packages with stretch film as said above with reference to FIGS. 1 and 2, or similar packages and/or which involve similar requirements, of a safety apparatus with the object of limiting the consumption of electricity by said final heat-sealing conveyor belt and of ensuring maximum safety for the operators in charge of using these packaging machines.

### BRIEF DESCRIPTION OF THE DRAWINGS

Further objects and features of the invention will be apparent from the following description of a preferred embodiment thereof, illustrated purely by way of non-limiting example in the figures of the four accompanying drawings where, besides FIGS. 1 and 2 considered above, it is specified that:

FIGS. 3 and 4 illustrate, in a schematic top plan view, two different types of improved packaging machine according to the invention;

FIG. 5 illustrates details observed according to the line V-V of FIG. 3;

FIG. 6 illustrates other details observed according to the section VI-VI of FIG. 5;

FIGS. 7 and 8 illustrate corresponding details observed according to the sections VII-VII and VIII-VIII of the machine of FIG. 4.

### DETAILED DESCRIPTION

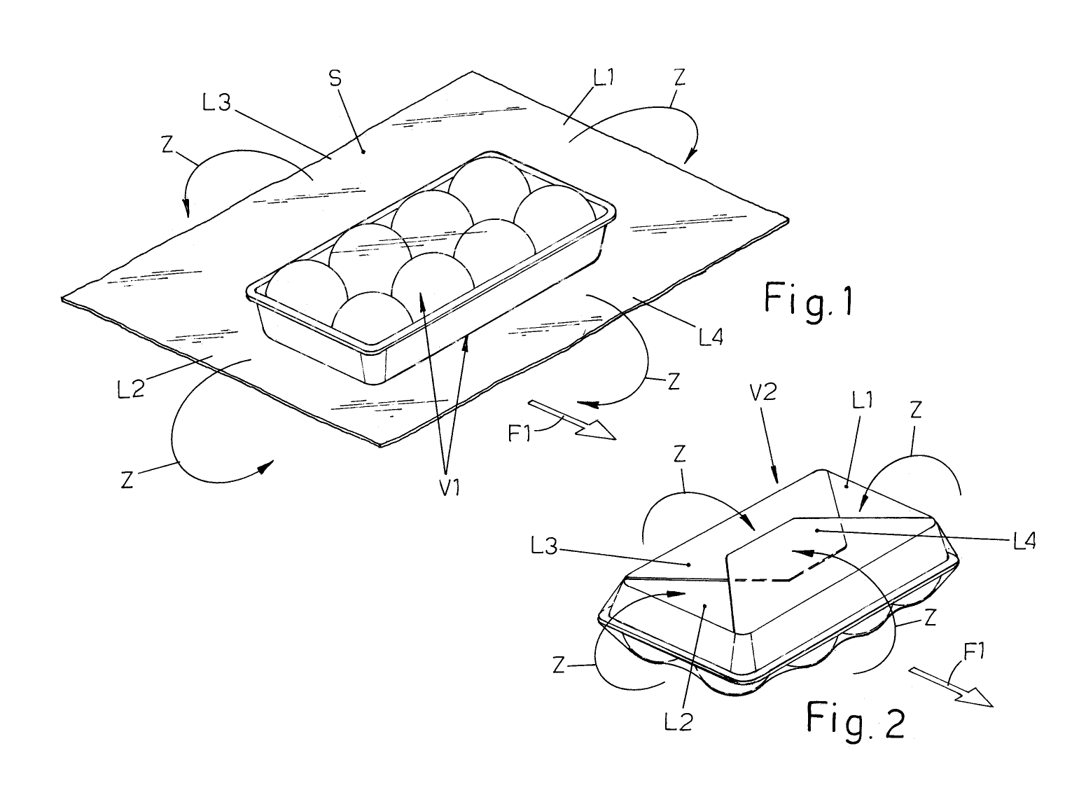

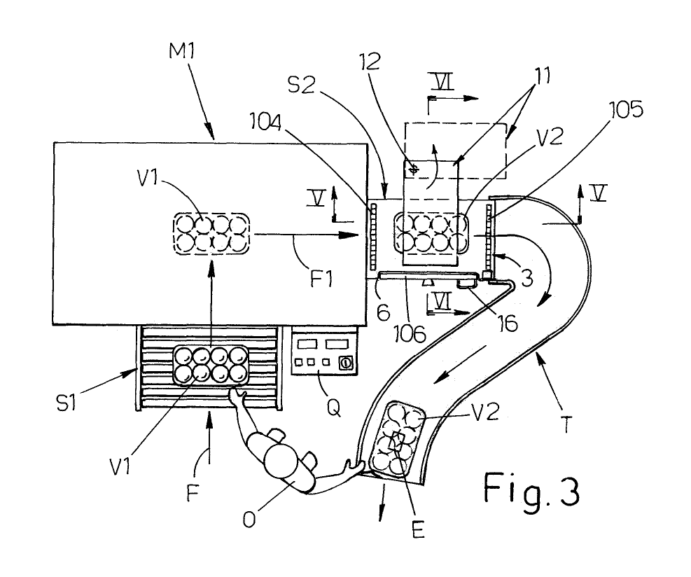

The applicant has for some time produced packaging machines for forming packages as shown in FIGS. 1 and 2, for example known with the trade names ELIXA ZX, MEGA or MAX, produced with the layout shown in the plan view of FIG. 3, where M1 indicates the packaging machine provided with a station S1 for feeding and controlling the size and weight of the product to be packaged V1, which enters the same machine with a movement according to the arrow F, which inside the same machine is wrapped with a sheet of stretch film as said with reference to FIG. 1 and which is then discharged from M1 with the orthogonal movement indicated by the arrow F1 to be conveyed to the final station S2, where the lower edges of the packaged product V2 are heat-sealed and from which the same package is unloaded in the same direction F1 of feed into S2 and is, for example, picked up by a curvilinear descending conveyor that channels the same packaged products V2 in a flow that passes laterally and in proximity to the same operator O controlling the feed station S1 and in front of whom the control panel Q of the machine M1 is available.

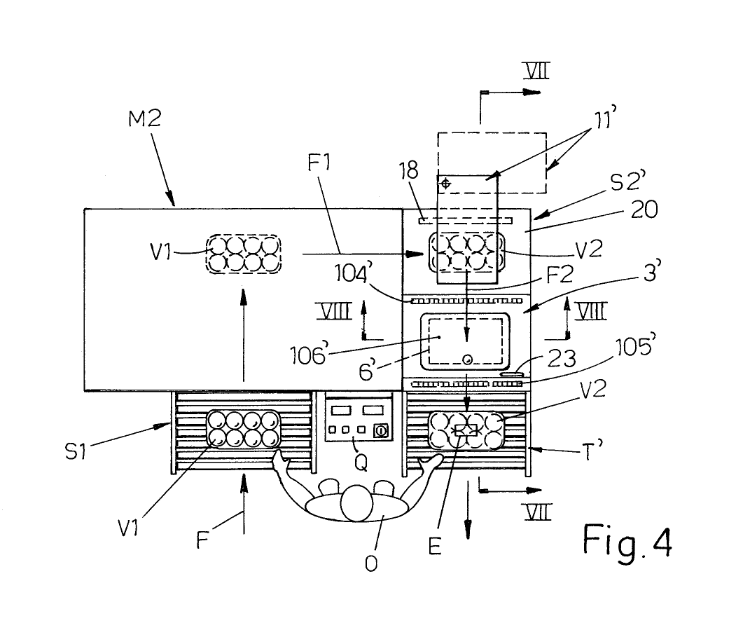

Other packaging machines known with the trade name ELIXA XP are of the type indicated with M2 in FIG. 4, are provided with the usual station Si for feeding and controlling the size and optionally the weight of the product V1 to be packaged which is fed in the direction F, wrapping the same product as said above with reference to FIG. 1, after which the same product is translated orthogonally according to the direction F1 to be fed, packaged and as indicated with V2 in FIG. 2, to the discharge and heat sealing station S2′, from which the same product V2 is removed with a movement F2 orthogonal to F1 and fed to a conveyor T′ for removal and for optional control of the weight, parallel to that of the same feed station S1, to allow control of the machine by a single operator O who, also in this case, has the control panel Q of the machine M2 in front of him/her.

To make rational use of the footprint of the machines M1 and M2, the reel of stretch film with the unit for feeding the same film to the packaging station, are placed in a known manner under the final stations S2, S2′, so that to facilitate reel change and the necessary adjustment and/or maintenance operations, the components of the same stations S2, S2′ must be arranged so that it is possible to move them easily and rapidly away from the underlying lower film feed means, for example with a swinging movement that then, just as easily, allows these same components of S2, S2′ to be returned to the lower operating position.

The current trend of packaging machine manufacturers is to provide these machines with protective casings that cover the moving members, to prevent the operator from coming into accidental contact therewith and to provide safety micro switches, so that, if said casings are raised or removed, the machine automatically stops operating if it has not previously been switched off or made safe by the operator. The invention proposes an apparatus with a protective casing also for the stations S2, S2′ for discharge of the product, contrary to the trend of many manufacturers of packaging machines, which in order to allow rapid manual removal of the product from the heat-sealing conveyor in the case of accidental or temporary stopping of the machine, or to allow the operator to take rapid action in the station S2, S2′ to remove labelled packages from a labelling machine 11, illustrated in FIGS. 3 and 4 with an unbroken line in the operating position (see below), leave the heat-sealing conveyor without any protective casing, with the drawback of loss of heat from this component into the work environment and consequent increased electricity consumption by this component, with the possibility of the operator getting burnt by touching this same conveyor, usually very hot, with his/her hands, and with the possibility of the same operator coming into contact with internal moving parts of the stations S2, S2′ or even touching parts in proximity of these stations inside the packaging machines M1 or M2. As prior art, it is possible to cite, for example, the patents EP 1.571.092 by Teraoka Seiko Co. Ltd, with priority of 2004, and the following further patent application publications: DE 10 2008 053665, EP 940 343 and DE 30 10 657.

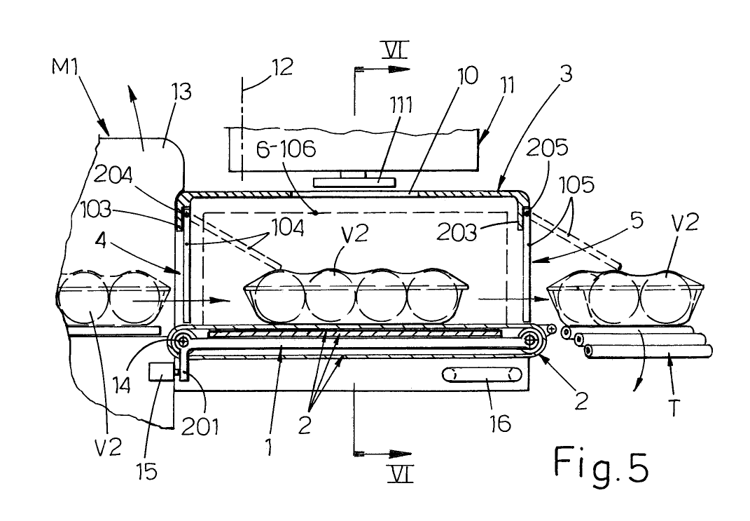

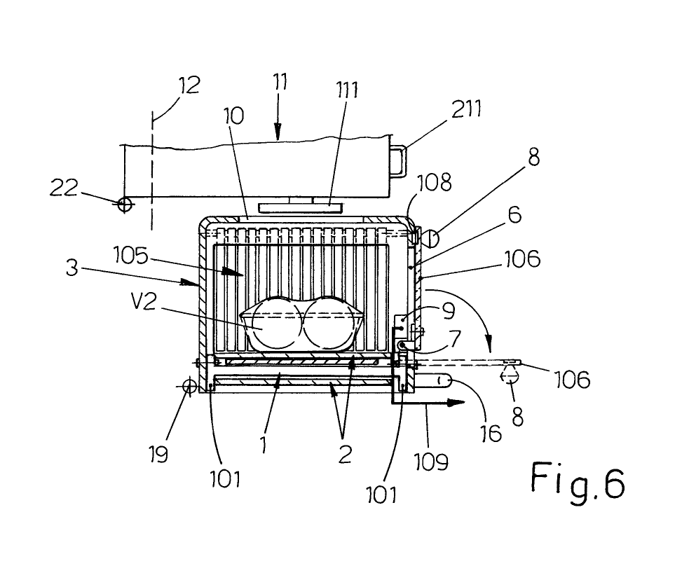

To overcome all these problems of the prior art, as illustrated in FIGS. 3, 5 and 6, the invention provides for securing to lateral appendices 101 of the structure, schematically indicated with 1 and which support the guide rollers and heating plate of the heat-sealing conveyor 2, which with its upper branch travels in the direction of the arrow F1, so as to be on top of and to incorporate the same conveyor 2, a parallelepiped-shaped chamber 3 made of any material or combination of materials with good heat insulating properties and having a size such as to allow conveying, without interference, of the packages of products V2 that are delivered from the machine and that are conveyed on the heat-sealing conveyor 2, also of those packages of the largest size that can be processed by the same machine, this chamber 3 being provided with openings 4 and 5, opposite and aligned with each other, positioned at the ends of the conveyor 2 and for which the same chamber 3 substantially acts as a tunnel. The openings 4 and 5 are closed by swinging barriers 104, 105, advantageously formed by a plurality of vertical and rigid slats of plastic material, with rounded profile, pivoted on transverse and upper axes 204, 205 supported by the upper horizontal sides of the openings 4 and 5 of the chamber 3, to form first, second or third class levers, for which there are provided on the same upper horizontal side of the openings 4, 5 and/or in another suitable position, stops 103 and 203 or the like, against which said barrier slats can rest when they are in the closing position and so that the same barrier slats can swing only in counter-clockwise direction, for those observing FIG. 5, being raised by the thrust of the packaged product V2 fed from the packaging machine M1 and then by the same product V2 that leaves the heat-sealing conveyor 2, exits from the chamber 3 and is fed to the removal conveyor T as in FIG. 3. After the product has passed beyond the raised slats of the barriers 104, 105, these return through gravity to the vertical position for closing the openings 4 and 5, maintaining in the chamber 3 the heat generated by the conveyor 2, which in this way is not lost into the work environment and limits the consumption of electricity by the same conveyor 2. If from their vertical rest position the barriers 104 and 105 were to be thrust to rotate in clockwise direction, for those observing FIG. 5, for example by the operator's hands, this movement would be prevented by the rigidity of the single slats that form the same barriers 104, 105 and by the fact that the same slats would be thrust against the upper stops 103 and 203 that would prevent such swinging thereof in clockwise direction. Therefore, the swinging barriers 104, 105 also act as safety barrier, due to the fact that they prevent objects from entering the chamber 3 through the discharge opening 5 and prevent backflow of objects from the chamber 3 to the machine M1 through the feed opening 4. In order to place a hand inside the chamber 3, the operator would have to lift a single slat of the external barrier 105 with his/her fingers so as to open therein a small passage into which a finger could be inserted and, using this finger, lift several adjacent slats of the same barrier, in a quantity such as to allow the formation of a larger passage that would allow a hand to pass through. This method of operating would require more time and more risks than the following possibility of rapid and safe access to the chamber 3 provided by the invention, by providing the lateral wall of the same chamber 3 facing the operator 0 with a large window 6 closed by a door 106 preferably made of transparent material, to allow maximum visibility of everything that happens inside the same chamber 3, as to satisfy its heat insulating needs, it is not possible to produce the same protective chamber 3, inexpensively and safely, with transparent material. The door 106 can be made of the same material as the material of which the door of small electric ovens for domestic use are made and, just as these, is preferably characterized by being hinged to the window 6 of the chamber 3 with a horizontal lower hinge 7, so that it can be opened with downward swinging through 90° and remain firmly in the open position through gravity and maximum opening swing of said hinge 7. The door 106 is provided on the upper horizontal side with an outer gripping knob 8 and is provided with any suitable means that maintain it safely in the raised position to close the chamber 3, as illustrated with the unbroken line in FIGS. 3 and 6, for example with elastic means of known type, that act on the hinge 7 or with a snap or magnetic type closure 108 positioned partly on the upper horizontal side of the door 106, for example in association with the knob 8, and placed partly on the upper horizontal side of the window 6. Opening the door 106, the operator is able to rapidly access the inside of the chamber 3 with one hand, to remove a package V2 that would otherwise remain stationary on the conveyor 2, with the safety of not touching the conveyor 2 and the safety provided by the presence of the swinging barrier upstream 104, which will prevent the same operator from entering the machine with his/her hands or from inserting undesirable parts into the same machine M1. From the detail of FIG. 6 it can then be observed that with the hinge 7 there is associated a micro switch 9, from which there departs an electrical contact 109 that is sent, directly or indirectly, to the control panel Q of the machine (FIG. 3), which is arranged so that if the micro switch 9 is activated due to opening of the door 106, the machine is automatically stopped and the power supply to the various components thereof, including the heat-sealing conveyor 2, is disconnected. Vice versa, by closing the door 106 and when the micro switch 9 transmits a signal that communicates this condition, the control panel Q is arranged so that by acting, for example, on the start button, the packaging machine can start up again rapidly and from the point in which it stopped, with opening of the door 106, without activating, or reducing, the verification and diagnostics protocols that are instead required for other causes of accidental stopping of the same packaging machine.

The chamber 3 can be provided at the top with an opening 10 for passage of the movable pad 111 of a labelling machine 11 that affixes at least one label E (FIG. 3) to the packaged product V2, stopped or temporarily decelerated on the heat-sealing conveyor 2, for qualification and/or pricing of the same packaged product. The labelling machine 11 can, for example, be mounted so that it can rotate on a vertical axis 12, to be able to be taken from the operating position illustrated with an unbroken line in FIG. 3, to a rest position indicated with a broken line, in which the same labelling machine is positioned laterally to the footprint of the chamber 3, to allow this chamber and the whole of the heat-sealing conveyor 2 assembly to be lifted after the casing upstream 13 that covers the packaging machine M1 has been raised. For this purpose, in FIG. 5 it can be observed that the whole assembly of the structure 1 carrying the heat-sealing conveyor 2 and the chamber 3 is, for example, pivoted on a base structure, not illustrated, with hinge on an axis coincident with or parallel to the first axis 14 for guiding and driving the same heat-sealing conveyor 2 and it can also be observed that when the same structure 1, directly or by interposing an appendix 201, is in the horizontal operating position it rests on a stop 15, usually provided with a micro switch to communicate this condition to the control panel Q. In FIG. 5 it can also be observed that the structure 1 or the chamber 3 and the labelling machine 11 are provided laterally with respective handles 16, 211, by acting on which the operator can move the labelling machine away and can lift the same structure 1 with the conveyor 2 and with the chamber 3 in clockwise direction to allow access to the underlying feed means of the packaging film, not illustrated as they are known and irrelevant to an understanding of the invention.

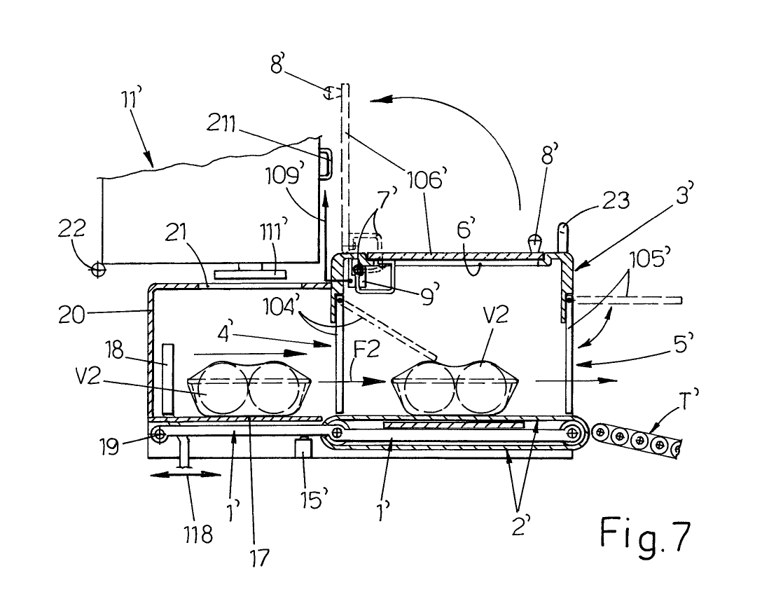

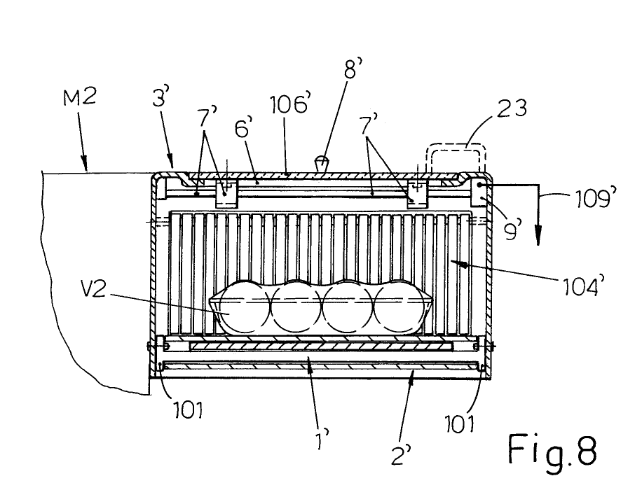

In a different solution to the one described above, see FIG. 6, it can be provided that the structure 1 is prearranged so that it can swing not on said axis 14 but on an axis 19 horizontal and parallel to the direction of feed F1 and so that the labelling machine 11 can swing on an axis 22 parallel to the axis 19, substantially as described now with reference to FIGS. 7 and 8, which illustrate in particular the improvements in question made to the machine M2 of FIG. 4.

FIG. 7 shows that the structure 1′ that carries the heat-sealing conveyor 2′ with the protective chamber 3′ above, upstream of these components supports an exchange platform 17 coplanar to the upper branch of the same conveyor 2′, on which the packaged product V2 is conveyed to the exit from the machine M2 and along which a pusher 18 operates, which through known means for alternated movement according to the arrows 118, transfers the same product V2 from this platform 17 to the conveyor 2, with raising of the swinging barrier 104′. The supporting structure 1′ is in this case hinged on an axis 19 placed on the outer side of the exchange platform 17, parallel to the direction F1 of delivery of the product V2 from the packaging machine M2 and in the lower operating position, the same supporting structure 1′ rests on a stop 15′, if necessary with a micro switch to communicate this condition to the control panel Q of the machine M2. On top of the exchange platform 17 is an auxiliary protective chamber 20 with opening to 90° to receive the product V2 from the machine M2 and then allow translation of the same product by the pusher 18 and insertion of the same product V2 into the chamber 3′, said auxiliary chamber 20 being provided with an optional upper opening 21 for passage of the pad 111′ of an optional labelling machine 11′ mounted, for example, so that it can swing on an axis 22 parallel to the axis 19. In this case, to be able to access the feed means of the film in the machine M2, through the relevant handle 211 the optional labelling machine 11′ is first raised, with swinging about the axis 22 and then the structure 1′ with all the annexed parts, is raised, acting on a handle 23 secured, for example, to the upper part of the protective chamber 3′, in a comfortable position for the operator O of FIG. 4. To allow the operator to act rapidly on the packaged product that would remain stationary on the heat-sealing conveyor 2, in this case the chamber 3′ is provided with an upper window 6′ closed by a door 106′ hinged on a hinge 7′ parallel to the axis 19, provided with a firm open position to 90° of the door 106′ and that also in this case acts on a micro switch 9′ with electrical connection 109′ to the control panel Q. In this case the door 106′ remains firmly closed through gravity and therefore does not require the closing means indicated with 108 in FIG. 6.

To prevent the openings 10 and 21 from becoming an unsafe passage for the operator, if the labelling machine 11 or 11′ is moved away from these openings, there can be associated with the same labelling machine safety micro switches, not illustrated, electrically connected to the control panel Q to limit operation of the packaging machine if the same labelling machines are not in the correct operating position.

To improve the visibility of the inner parts of the protective chamber 3, at least the swinging protective barrier 105′ could be made with slats of transparent plastic material.

It is understood that the description refers to some preferred embodiments of the invention, to which numerous variants, modifications and construction equivalences can be made, all without departing from the overarching principle of the invention, as described, illustrated and as claimed below. In the claims, the references provided in brackets are purely indicative and do not limit the scope of protection of the same claims.

1. Machine for packaging products with stretch film the flaps of which are stretched, folded and mutually superimposed on the bottom of the product usually arranged in a tray, comprising a final station with a motorized heat-sealing conveyor to mutually secure said flaps with a heat-sealing operation, characterised in that this final heat-sealing station is provided with an upper protective chamber for the operator, and which limits the loss into the work environment of heat produced by said heat-sealing conveyor, now incorporated in this protective chamber, which has a shape and size such as to allow the packaged products to be conveyed there through without interference, this protective chamber being provided with an inlet opening usually communicating with the casing of the packaging machine and being provided with an outlet opening for conveying the packaged products wherein at least this last outlet opening is closed by a swinging barrier that prevents loss of heat towards the outside and that is arranged to swing and open only in the direction of normal flow of the packaged products and due to the thrust of these latter, but which cannot swing in the opposite direction, to act also as safety barrier, said protective chamber being provided on at least one of the walls not involved by said swinging barriers and in view, with at least one window closed by at least one door preferably made of transparent material, which in the open position allows the operator to rapidly remove the packaged product stationary on the heat-sealing conveyor, there being provided safety means to automatically shut down at least the power supply to this heat-sealing conveyor when said door is opened.

2. Machine according to claim 1, wherein said protective chamber is provided with swinging safety barriers on both the inlet and outlet openings, to prevent loss of heat and backflow of objects also towards the packaging machine.

3. Machine according to claim 2, wherein said swinging and safety barriers are formed by a plurality of vertical and rigid slats made of plastic material, with rounded profile, pivoted on transverse axes supported by the upper horizontal sides of the openings of the protective chamber, which form first, second or third class levers and which, in the closing position cooperate with stops, that allow these levers to swing only as a result of the feed and of the thrust by the packaged product fed from the packaging machine and then by the same packaged product that leaves the heat-sealing conveyor, exits from the protective chamber and is fed to the removal conveyor, it being provided that when the packaged product has passed beyond the raised slats of said swinging barriers these return through gravity to the vertical position for closing the relevant openings.

4. Machine according to claim 1, characterised in that if the packaged product passes through the protective chamber in the same direction as the discharge direction of the same packaged product from the packaging machine, said window closed by the preferably transparent door is provided on the lateral wall of said protective chamber facing the operator using the same machine, said door being hinged with the lower horizontal side by means of a hinge with rotation of around 90° and with which there is associated a micro switch electrically connected via a wire to a control panel of the packaging machine to automatically stop operation and disconnect the power supply of the same packaging machine in the case of opening of said door, which is provided on the upper side with an outer knob with which there can be associated a component of a snap or magnetic closure, the second component of which is mounted on or at the upper side of the window and which is useful for maintaining the same door in the top closing position.

5. Machine according to claim 4, wherein said protective chamber is provided on the upper wall with an opening to allow passage of the movable pad of a labelling machine that affixes at least one label to the packaged product, stopped or temporarily decelerated on the heat-sealing conveyor, for qualification and/or pricing of the same packaged product, the same labelling machine being arranged so that it can be moved away from the footprint of the protective chamber below to allow maintenance operations on the same labelling machine and to allow lifting of the whole assembly of the heat-sealing conveyor with the annexed protective chamber to uncover, for maintenance or filling operations, the underlying feed means of the stretch film to the packaging machine.

6. Machine according to claim 5, wherein the labelling machine is arranged to swing on a vertical axis positioned on the side of the protective chamber that is not provided with the door, while the whole structure that supports the heat-sealing conveyor and relevant protective chamber is arranged to be able to swing on an axis coincident with or parallel to the axis of the first guide roller of the heat-sealing conveyor, there being provided limit stop means to support said structure in the horizontal operating position, and said labelling machine and the same structure being provided with respective safety micro switches to indicate whether they are in active or inactive position and being provided laterally with respective handles to allow movement of the labelling machine and raising of this structure and of all the components mounted thereon, each time it is necessary to take action on the underlying feed means of the packaging film.

7. Machine according to claim 5 wherein the labelling machine is arranged to be able to swing on an axis parallel to the longitudinal axis of the heat-sealing conveyer and positioned on the side of the protective chamber opposite the side with the swinging transparent door, while a structure that supports the heat-sealing conveyor and the relevant protective chamber is arranged to be able to swing on an axis parallel and near to the aforesaid axis of the labelling machine, there being provided limit switch means to support said structure in the horizontal operating position, and the same structure and said labelling machine being provided with respective safety micro switches to indicate whether they are in active or inactive position and being provided laterally with respective handles to allow the operator to move and lift said components each time this is required to take action on the underlying feed means of the packaging film.

8. Machine according to claim 4, characterised in that if the packaged product passes through the protective chamber in a direction perpendicular to the direction for discharge of the same packaged product from the packaging machine, said window closed by the swinging transparent door is provided on the upper wall of said protective chamber, and this door uses a rear hinge with swing amplitude of around 90°, with which there is associated optional means for stabilizing during opening and with which there is associated a micro switch electrically connected via a wire to the control panel of the packaging machine to automatically stop operation and disconnect the power supply of the same packaging machine in case of opening of said door, which is provided on the upper side with an outer gripping knob, said heat-sealing conveyor and the relevant protective chamber being mounted on a swinging structure supported in horizontal position by limit stop and indicator means and on this swinging structure there is mounted upstream of said protective chamber an auxiliary chamber with an internal exchange platform and provided with an opening of 90° to receive the packaged product from the packaging machine and to transfer the same packaged product onto the heat-sealing conveyor, by means of a pusher, this auxiliary chamber being provided with an optional upper opening for passage of the movable pad of an optional labelling machine hinged on an axis parallel to the lower swing axis of said structure, which is in turn parallel to the direction of discharge of the packaged product from the packaging machine, said protective chamber and said labelling machine being provided with respective gripping handles to allow said lifting and lowering movements of these components which are controlled and indicated by respective safety micro switches.

9. Machine according to claim 3, wherein at least the components of the swinging barrier positioned on the discharge opening of the protective chamber are made of a transparent material that makes it possible also to see through this swinging barrier what is happening inside said protective chamber.

10. Machine according to claim 4, characterised in that it comprises in the control panel of the same packaging machine electronic components so that after closing of the door of the protective chamber, when the safety micro switch of the same door transmits a signal that communicates this closed condition, for example by acting on the start button of the same control panel, the packaging machine can start up again rapidly from the point in which it stopped automatically with opening of said door, without activating or reducing the verification and diagnostics protocols that are instead required for other causes of accidental stopping of the same packaging machine.
